(19) United States
(12) Patent Application Publication
(10) Pub. No.: US 2026/0005761 A1
(43) Pub. Date: Jan. 1, 2026

(54) METHODS AND APPARATUS FOR CONNECTING DEVICES IN A COMMUNICATION SYSTEM

(71) Applicant: Telefonaktiebolaget LM Ericsson (publ), Stockholm (SE)

(72) Inventors: Sergio MOSTI, Genova (IT); Claudio D’INCÁ, Genova (IT); Paolo DEBENEDETTI, Genova (IT); Raoul FIORONE, Genova (IT)

(21) Appl. No.: 19/111,907

(22) PCT Filed: Sep. 14, 2022
(86) PCT No.: PCT/EP2022/075582

§ 371 Date: Mar. 14, 2025

(51) Int. Cl. H04B 10/073

(52) U.S. Cl. CPC H04B 10/073

(57) ABSTRACT

The disclosure provides, inter alia, a communication device comprising: a plurality of connector ports for receiving corresponding connectors affixed to cables carrying optical signals, the plurality of connector ports comprising a first connector port configured to receive optical signals having a first value for a signal characteristic, and a second connector port configured to receive optical signals having a second value for the signal characteristic; a plurality of visible indicator devices associated with the connector ports, the plurality of visible indicator devices comprising a first visible indicator device located adjacent to the first connector port, and a second visible indicator device located adjacent to the second connector port; and short-range wireless communication circuitry configured to: receive, from a short-range wireless communication device, an indication of a value of the signal characteristic for a communication signal carried by a cable; and, responsive to a determination that the indicated value for the signal characteristic corresponds to the first value, activate the first visible indicator device.

### TECHNICAL FIELD

Embodiments of the disclosure relate to communication systems, and particularly to methods and apparatus for physically inter-connecting devices in a communication system.

### BACKGROUND

It is an observation that devices within a communication system need to be communicatively connected to each other. That is, one device or component of the communication system outputs communication signals, and these signals are provided as inputs to another device or component of the system. Physical connections, e.g., electrical or optical cabling, are associated with high simplicity, low cost and low data loss, and are therefore the preferred mechanism for carrying such communication signals when the distance between devices of the system allows.

It is also an observation that cables must be connected between the correct connectors on those devices for the system to function correctly.

For example, wavelength divisional multiplexed (WDM) systems transmit information over optical fibres using optical signals having different wavelengths (also referred to as “lambdas”). Each wavelength is modulated with and corresponds to a different stream of data, and optical devices such as filters, demultiplexers and multiplexers enable multiple streams of data to be multiplexed on to the same optical fibre and/or single streams of data to be split off on to separate optical fibres. In this context, the connectors of such devices may be associated with signals having particular wavelengths and/or particular directions of transmission (e.g., transmit or receive). For example, an optical multiplexer may be designed to multiplex optical signals having a first wavelength received at a first input connector on to an output connector, and to multiplex optical signals having a second wavelength received at a second input connector on to the output connector. That is, the optical properties of components of the multiplexer (such as gratings, lenses, etc) may be designed to divert optical radiation having a specific wavelength from an input connector to an output connector through refraction and other optical effects. Optical signals received at the first input connector having a wavelength other than the first wavelength will not be successfully multiplexed on to the output connector, and nor will optical signals received at the second input connector having a wavelength other than the second wavelength. Thus, if an incorrect cable (i.e., carrying optical signals having a wavelength other than the first wavelength) is inserted into the first input connector, those optical signals and the information they carry will be lost.

While the need to connect devices in the correct manner is conceptually straightforward, the practical reality can be considerably more complex.

First, modern communication systems may comprise large numbers of physically identical connectors, tightly packed together on a faceplate of the device. Each connector may be provided with a label positioned close to it, comprising an identifier for the connector. However, the label is usually small, and the physical similarity between connectors means that correctly identifying and distinguishing between them is difficult and prone to error.

Second, the cables themselves may also be physically identical and difficult to tell apart. Each cable may also be provided with a label, either printed on it or attached to it, comprising an identifier for the cable. However, the label is typically small and difficult to read. Further, the physical configuration of devices may make it difficult to see to which connector the remote end of the cable is already connected (and thus which signal is being carried by the cable). For example, a device in one rack may require connection to a device in another rack. When connecting a first end of a cable to one device, the physical separation of these devices makes it difficult to see to which connector the second end of the cable is already connected.

Real-world experience from field engineers has shown that interconnecting devices in a communication system is both time-consuming and error-prone. A mechanism which addresses these problems is therefore desirable.

### SUMMARY

According to a first aspect of the disclosure, there is provided a communication device comprising: a plurality of connector ports for receiving corresponding connectors affixed to cables carrying optical signals, the plurality of connector ports comprising a first connector port configured to receive optical signals having a first value for a signal characteristic, and a second connector port configured to receive optical signals having a second value for the signal characteristic; a plurality of visible indicator devices associated with the connector ports, the plurality of visible indicator devices comprising a first visible indicator device located adjacent to the first connector port, and a second visible indicator device located adjacent to the second connector port; and short-range wireless communication circuitry configured to: receive, from a short-range wireless communication device, an indication of a value of the signal characteristic for a communication signal carried by a cable; and, responsive to a determination that the indicated value for the signal characteristic corresponds to the first value, activate the first visible indicator device.

According to a second aspect of the disclosure, there is provided a method, performed by a wireless device, for identifying connector components in a communication device comprising a plurality of connector ports for receiving corresponding connectors affixed to cables carrying optical signals, a plurality of visible indicator devices associated with the connector ports and short-range wireless communication circuitry. The wireless device comprises an input/output interface, and short-range wireless communication circuitry. The method comprises: receiving, via the input/output interface, an indication of an association between an identifier of a cable and a value of a signal characteristic of a communication signal carried by the cable; and transmitting, using the short-range wireless communication circuitry, an indication of the value of the signal characteristic to short-range wireless communication circuitry of the communication device, such that a corresponding visible indicator device is activated.

According to a third aspect of the disclosure, there is provided a wireless device, for identifying connector components in a communication device comprising a plurality of connector ports for receiving corresponding connectors affixed to cables carrying optical signals, a plurality of visible indicator devices associated with the connector ports and short-range wireless communication circuitry. The wireless device comprises processing circuitry, an input/output interface, and short-range wireless communication circuitry. The processing circuitry is configured to cause the wireless device to: receive, via the input/output interface, an indication of an association between an identifier of a cable and a value of a signal characteristic of a communication signal carried by the cable; and transmit, using the short-range wireless communication circuitry, an indication of the value of the signal characteristic to short-range wireless communication circuitry of the communication device, such that a corresponding visible indicator device is activated.

Embodiments of the disclosure have the technical advantage of providing engineers with a clear visual indication of a connector port that the cable should be connected to. In this way, the likelihood of errors when interconnecting communication devices is reduced.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 shows a system according to embodiments of the disclosure;

FIG. 2 shows a communication device according to embodiments of the disclosure;

FIG. 3 shows an indicator device according to embodiments of the disclosure;

FIG. 4 shows a cable according to embodiments of the disclosure;

FIG. 5 is a flowchart of a method according to embodiments of the disclosure;

FIG. 6 shows short-range wireless circuitry according to embodiments of the disclosure; and

FIG. 7 is a schematic diagram of a wireless device according to embodiments of the disclosure.

### DETAILED DESCRIPTION

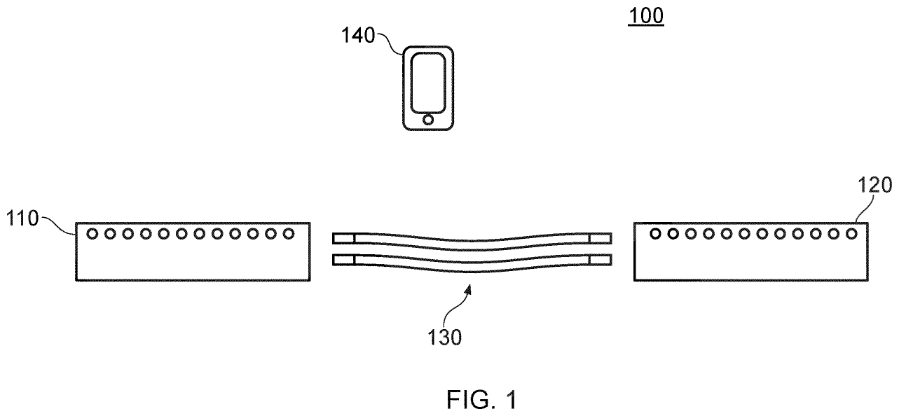

FIG. 1 shows a system 100 according to embodiments of the disclosure. The system 100 comprises a first communication device 110, a second communication device 120, a plurality of cables 130 and a wireless device 140.

The first and second communication devices 110, 120 form part of a communication system, and require interconnection via cables 130 carrying optical signals. Such communication systems can be found in many parts of modern communication networks. For example, the communication devices 110, 120 may form part of a radio base station; the first communication device 110 may comprise baseband processing circuitry, while the second communication device 120 may belong to radio receiving/transmitting circuitry. In other examples, the communication system may form part of other fronthaul equipment, backhaul equipment and/or core network nodes (such as switches or routers). Those skilled in the art will appreciate that embodiments of the present disclosure are applicable to a wide range of use cases.

The cables 130 comprise optical fibres terminated by transmit (TX) and receive (RX) connectors. These connectors are configured to engage with corresponding optical modules (e.g., hot-pluggable transceivers such as small form-factor pluggable transceivers, etc) in the first and second communication devices 110, 120. In further embodiments, break-out cables and active optical cables (AOC) are considered. In a breakout cable, one pair of TX/RX fibre connectors on one side is paired with four or more pairs of TX/RX fibre connectors. In AOC cables, the breakout cables are connected with active optical modules.

In one embodiment, the communication system uses wavelength division multiplexing (WDM) technology. According to this technology, a plurality of optical carrier signals may be multiplexed onto a single optical fibre using different wavelengths (also referred to as lambdas). Accordingly, each of the cables 130 may carry optical signals comprising one or a plurality of wavelengths.

One or both of the first and second communication devices 110, 120 may comprise an optical unit such as an optical filter, an optical multiplexer or an optical demultiplexer. Optical filters operate by passing optical signals having a particular wavelength or a particular range of wavelengths, and filtering out optical signals having different wavelengths. Optical multiplexers receive a plurality of optical signals having different wavelengths on a plurality of inputs, and multiplex those optical signals onto a single output. Optical demultiplexers perform the inverse function, receiving optical signals having different wavelengths on a single input, and outputting optical signals onto a plurality of outputs according to their wavelengths.

In some embodiments, the optical unit may be passive, i.e., performing a fixed filtering, multiplexing or demultiplexing function regardless of the optical signals that are input to it.

For example, an optical filter may perform a fixed filtering operation on an optical signal provided to a given input connector, e.g., passing optical signals having a wavelength in the range X and filtering optical signals having a wavelength outside that range. If the ‘wrong’ optical signal is provided to the input connector, i.e., an optical signal having a wavelength that falls entirely outside the range X, the optical filter will act to filter out the entire signal.

In another example, an optical multiplexer may act to multiplex an optical signal received at a given input connector (along with other optical signals received at different input connectors) onto a given output connector. However, the optical signal received at the given input connector will only be successfully multiplexed on to the output connector if it has a particular wavelength or range of wavelengths Y. As the multiplexer is passive, if the optical signal received at the given input connector has a wavelength other than Y, it will be lost and not successfully multiplexed to the output connector. In this way, an optical multiplexer can also perform a filtering function.

In a further example, an optical demultiplexer may act to demultiplex an optical signal comprising multiple wavelengths received at a given input connector onto a plurality of output connectors. However, the optical signal received at the given input connector will only be successfully demultiplexed on to the output connectors if it has the particular wavelengths or ranges of wavelengths Z corresponding to those output connectors. As the demultiplexer is passive, if the optical signal received at the input connector has a wavelength other than Z, it will be lost and not successfully demultiplexed to an output connector. In this way, an optical demultiplexer can also perform a filtering function.

The goal of an engineer installing or maintaining the communication system comprising the first and second communication devices 110, 120 is to ensure that optical signals are routed correctly between the two devices via the cables 130, i.e., that a cable 130 connected to a particular connector port on the first communication device 110 is connected to the correct connector port on the second communication device 120. As noted above, while this is conceptually straightforward, in practice such a task can be difficult and time-consuming owing to the number of visually identical cables and connector ports, and the possibility that a distal end of a cable may not be visible when connecting the proximal end of the cable to a connector port.

In order to address this problem, embodiments of the disclosure provide a mechanism for visually highlighting a connector port to which a given cable should be connected. In this way, engineers are provided with clear visual guidance as to which cable should be connected to which port. Further embodiments of the disclosure may also enable the cable itself to be visually highlighted.

One component of the mechanism according to embodiments of the disclosure comprises a wireless device 140. The wireless device may be a smart phone, laptop, tablet or other wireless device suitably programmed to perform the functions set out herein. Alternatively, the wireless device 140 may be a dedicated device for performing the functions set out herein.

The wireless device 140 comprises short-range wireless circuitry, such as near-field communication (NFC) circuitry, that can interact with short-range wireless circuitry provided on the first and second communication devices 110, 120 and/or the cables 130, e.g., through inductive coupling. The short-range wireless circuitry on the first and/or second communication devices 110, 120 is coupled to visible indicator devices associated with the connector ports. The wireless device 140 outputs a query message containing an indication of a signal characteristic of an optical signal carried by a particular cable 130 (e.g., wavelength, direction of transmission, port ID, etc), and the visible indicator device associated with that connector port activates. In this way, a particular connector port (e.g., a connector port associated with a particular wavelength, transmit direction, port ID, etc) is visually highlighted when required.

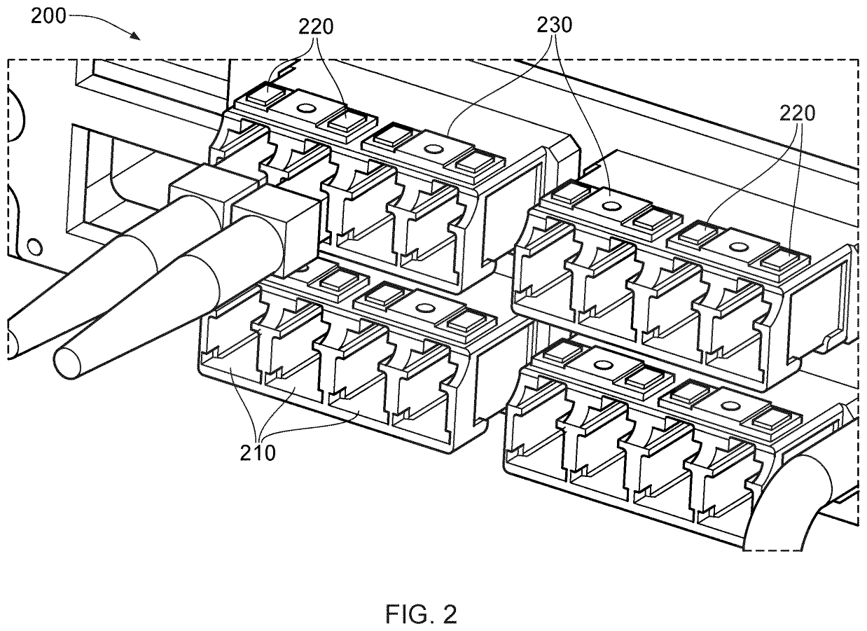

FIG. 2 shows a communication device 200 according to embodiments of the disclosure.

The communication device 200 comprises a plurality of connector ports 210, a plurality of visible indicator devices 220 and short-range wireless circuitry 230.

The communication device 200 may correspond to the first or second communication device 110, 120 described above with respect to FIG. 1. Thus the communication device 200 may comprise an optical device such as an optical filter, an optical multiplexer or an optical demultiplexer. Each connector port 210 may comprise an optical module (e.g., hot-pluggable transceivers such as small form-factor pluggable transceivers, etc) designed to receive a corresponding connector of an optical cable. In one embodiment, a connector port 210 may be connected to an optical module hosted by the communication device 200 via a patch cord.

Each connector port 210 is further configured to receive optical signals having a particular signal characteristic. That is, the optical properties of components of the optical device (such as gratings, lenses, etc) may be designed to divert optical radiation having a specific wavelength from an input connector to an output connector through refraction, filtering and other optical effects. Optical radiation having a different wavelength is not diverted to the output connector and is therefore lost. Thus, in one embodiment the signal characteristic comprises the wavelength of the optical signal. The signal characteristic may additionally or alternatively comprise the direction of transmission of the optical signal. That is, the optical device may be configured to receive an input optical signal at the connector port, or to provide an output optical signal at the connector port.

In some embodiments, the optical device may be passive, i.e., the optical device does not receive electrical power. The optical device may perform functions such as a fixed filtering, multiplexing or demultiplexing function regardless of the optical signals that are input to it. In other embodiments, the optical device may be active (e.g., receiving electrical power, e.g. configurable to provide a particular filtering, multiplexing or demultiplexing function). In either case, correction functioning of the communication device 200 requires optical signals having particular signal characteristics to be provided to the connector ports.

Each connector port 210 has a respective visible indicator device 220 associated with it. The visible indicator devices 220 may be positioned in a manner which makes it clear to an engineer that a particular visible indicator device 220 is associated with a particular connector port. For example, each visible indicator device 220 may be positioned adjacent to (e.g., just above or just below) a respective connector port 210. In this example, a single visible indicator device 220 is provided for each connector port 210.

The visible indicator devices 220 may comprise any suitable device that is operable under a suitable stimulus (e.g., an electrical stimulus such as a voltage or current, or other signal) to change its visual appearance. For example, the visible indicator devices 220 may comprise light-emitting diodes, electro-chromic devices (e.g., which may change their reflective state upon application of an electrical stimulus) or any other suitable device. The visible indicator devices 220 may be identical for each connector port (e.g., having the same appearance) or different (e.g., having a different colour or appearance). In the latter case, the different types of visible indicator device 220 may alternate between adjacent connector ports 210 to help distinguish between connector ports and visible indicator devices that are positioned close to each other.

Short-range wireless circuitry 230 is connected to each visible indicator device 220. In the illustrated embodiment, the short-range wireless circuitry comprises a plurality of short-range wireless communication circuits, with each short-range wireless communication circuit connected to one or more visible indicator devices 210. In the illustrated embodiment, each short-range wireless communication circuit is connected to two visible indicator devices 220; however, those skilled in the art will appreciate that each short-range wireless communication circuit may be coupled to any number of visible indicator devices 220. In the example of one visible indicator device 220 for each connector port 210, the short-range wireless communication circuit is configured to handle the independent operation of the plurality of visible indicator devices 220.

The short-range wireless circuitry 230 is operable to communicate with corresponding short-range wireless circuitry in the wireless device (e.g., wireless device 140). For example, the short-range wireless circuitry 230 may comprise passive circuitry which is powered via inductive coupling with the short-range wireless circuitry of the wireless device 140. In one embodiment, the short-range wireless circuitry 230 is operable to communicate using near-field communication (NFC).

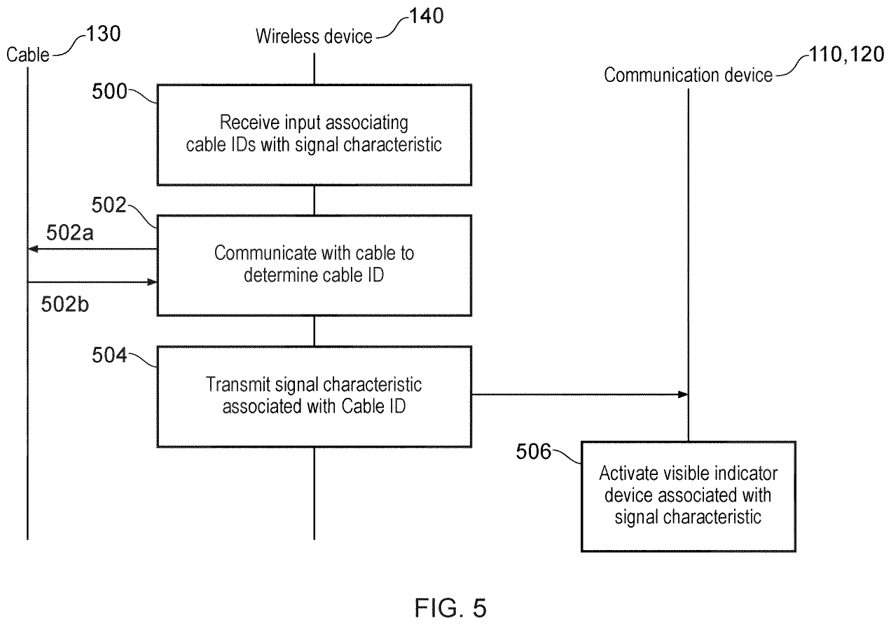

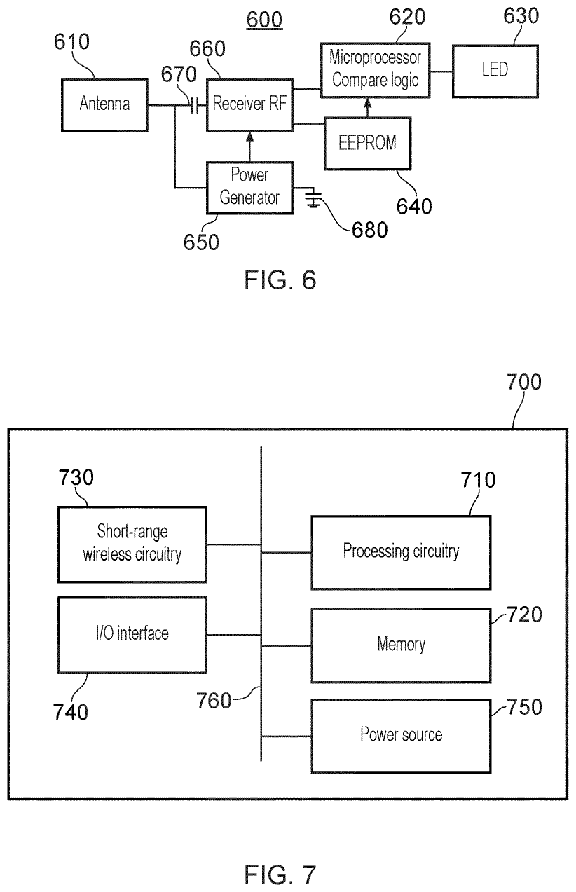

Further detail regarding the operation of the short-range wireless circuitry 230 is provided below with respect to FIG. 5. Further detail regarding the structure of the short-range wireless circuitry 230 according to one embodiment is provided below with respect to FIG. 6.

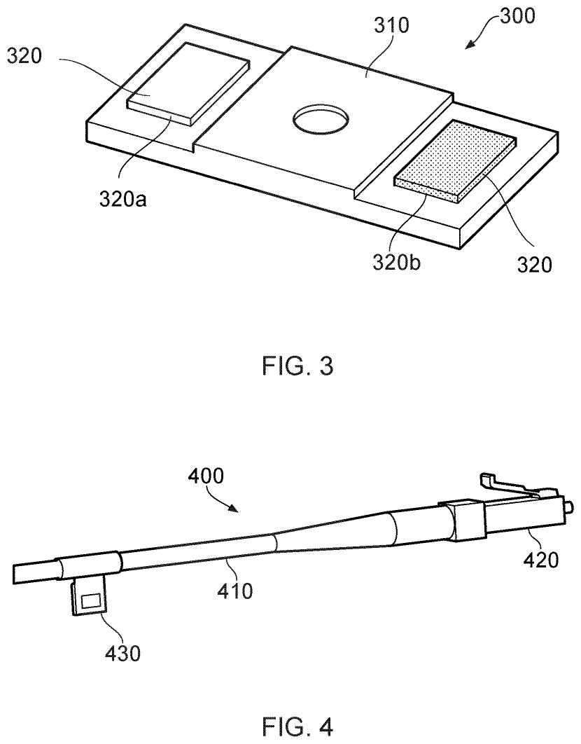

In the illustrated embodiment, and as shown in more detail in FIG. 3, the visible indicator devices and short-range wireless circuitry may be arranged within visible indicator assemblies 300. Each visible indicator assembly 300 comprises a short-range wireless communication circuit 310 and one or more visible indicator devices 320. In the illustrated embodiment, the assembly comprises two visible indicator devices 320a, 320b, such that more than one visible indicator device is associated with the same short- range wireless communication circuit. In some examples, the short-range wireless communication circuit 310 is configured to separately operate the plurality of visible indicator devices according to the received signal indicating the optical signal characteristics. As such, even though two (or more) visible indicator devices share a short-range wireless communication circuit, the short-range wireless communication circuit is configured to activate a single visible indicator device in order to indicate a single correct connection port.

Those skilled in the art will appreciate that any number of visible indicator devices may be associated with the same short-range wireless communication circuit, including a single visible indicator device and more than two visible indicator devices.

In the illustrated embodiment, the two visible indicator devices 320 of a visible indicator assembly 300 have different appearances (e.g., different colours, such as red and green). Once the assembly 300 is affixed to a communication device, a visible indicator assembly 300 is positioned next to one or more connector ports. In some examples, adjacent connector ports are associated with visible indicator devices having a different appearance. For example, adjacent visible indicator devices are differently coloured, e.g. generate different colour light when activated. In some examples, a first type of indicator (e.g. having a first colour) is used for transmission ports. A second type of indicator (e.g. having a second colour) is used for receive ports. A visible indicator device is configured to identify to a user of the wireless device that the associated port is the correct port for the identified cable.

In some embodiments, one or more of the cables 130 may also comprise a visible indicator device. FIG. 4 shows part of a cable 400 according to such embodiments of the disclosure.

The cable 400 comprises an optical fibre 410 and a connector 420 at a first end (the second end, not illustrated, also comprises a corresponding connector). The cable 400 also comprises a visible indicator device 430 positioned towards the first end of the optical fibre 410. In the illustrated embodiment, the visible indicator device 430 is affixed to the optical fibre 410; in other embodiments, the visible indicator device 430 may be affixed to the connector 420.

In some examples, the optical fibre 410 comprises one or more fibre identifiers. The fibre identifiers may be associated with the visible indicator device, or may be separate or be attached to the optical fibre even when no visible indicator device is present. In some examples, the optical fibre comprises a first fibre identifier adjacent one end of the fibre, and a second fibre identifier adjacent another end of the fibre. In this case, both the first and second fibre identifiers indicate the same identity. Alternatively, the optical fibre comprises only one fibre identifier, either adjacent an end, the middle or elsewhere on the optical fibre. In some examples, the fibre identifier is readable using a short-range wireless communication, e.g. NFC.

The visible indicator device 430 may be similar in structure and operation to the visible indicator devices 220, 320 described above with respect to FIGS. 2 and 3. Thus the visible indicator device 430 may comprise a light-emitting diode, an electro-chromic device or any other suitable device.

Short-range wireless circuitry (not illustrated) is connected to the visible indicator device 430. Again, the short-range wireless circuitry is operable to communicate with corresponding short-range wireless circuitry in the wireless device (e.g., wireless device 140), and may comprise passive circuitry which is powered via inductive coupling with the short-range wireless circuitry of the wireless device 140. The short-range wireless circuitry powers the associated visible indicator device. In one embodiment, the short-range wireless circuitry is operable to communicate using NFC. Further detail regarding the structure of the short-range wireless circuitry according to one embodiment is provided below with respect to FIG. 6.

FIG. 5 is a flowchart of a method according to embodiments of the disclosure. The flowchart shows the interaction of a wireless device (such as wireless device 140 described above with respect to FIG. 1), a cable (such as cable 130) and a communication device (such as communication device 120 or 200). It will be apparent to those skilled in the art that communication between the wireless device 140 and the cable 130 involves interaction of the short-range wireless circuitry of the wireless device 140 with short-range wireless circuitry provided on the cable 130. Similarly, communication between the wireless device 140 and the communication device 120, 200 involves interaction of the short-range wireless circuitry of the wireless device 140 with short-range wireless circuitry associated with the visible indicator devices.

The method is performed in the context shown in FIG. 1, whereby an engineer has the problem of connecting a first communication device 110 to a second communication device 120 using a plurality of cables, and the method has the goal of highlighting the correct connector port for a particular cable. In particular, the method allows for more efficient connection of a cable to the correct connector port of a passive communication device. In this way, an engineer is provided with clear visual feedback as to which connector port the cable should be connected.

In step 500, the wireless device receives an input that associates cable identifiers (IDs) for the plurality of cables with corresponding signal characteristics for the optical signals that are to be transmitted using those cables. For example, an engineer may connect first ends of the cables to the connector ports of a first communication device. The identifier for that cable may then be input by the engineer to the wireless device along with a value or values for the signal characteristic(s) of optical signals carried by the cable. For example, a first cable ID may be associated with an optical signal having a signal characteristic of a wavelength, e.g. λ₁, and a particular direction of travel (e.g., from the first communication device to the second communication device). A second cable ID may be associated with optical signals having wavelength λ₂ and a particular direction of travel (e.g., from the first communication device to the second communication device); and so on, repeated for each of the cables to be connected between the first and second communication devices. This data may be stored in local memory of the wireless device 140, or in memory which is accessible to the wireless device (e.g., a server based in the cloud).

The engineer then has the task of connecting second ends of the cables to the correct connector ports of the second communication device 120. The correct connector port may be based on the connector port used in the first communication device.

In step 502, optionally, the wireless device communicates with the cable 130 to determine the ID of that cable.

Such communication may take place in a number of different ways according to different embodiments of the disclosure. For example, in one embodiment, the wireless device 140 transmits a query or read message 502a to short-range wireless communication circuitry provided on the cable 130. The short-range wireless communication circuitry provided on the cable 130 is coupled to memory which stores the cable ID for that cable. The wireless device 140 then receives a response message 502b from the short-range wireless circuitry of the cable comprising an indication of the cable ID.

In another embodiment, the wireless device 140 may in step 502 transmit an indication of a particular cable ID to short-range wireless circuitry associated with the cable. If the cable ID received from the wireless device 140 corresponds to the cable ID stored in memory for the cable, a visible indicator device (e.g., as shown with respect to FIG. 4) is activated. In this context, a cable ID may correspond to the cable ID stored in memory if the cable IDs match in whole, or in relevant part. This embodiment has the advantage of enabling the engineer to rapidly find a particular cable from among the plurality of cables.

In a further embodiment, the wireless device 140 may not communicate with the cable 130 to determine the cable ID. Rather, the cable may be provided with a label or other tag with the cable ID imprinted upon it and visible to the engineer. The engineer may then enter the cable ID to the wireless device 140 or manually search (e.g., by scrolling through) the associations stored in step 500 to find the cable ID and its associated signal characteristic.

Thus, after step 502, the engineer has identified a cable having a particular known cable ID. With the association between cable IDs and signal characteristics stored in step 500, the engineer and/or the wireless device also has knowledge enabling the ‘correct’ connector port for that cable ID to be identified.

In some examples, the cable ID is available to the wireless device at an end of the cable which is adjacent to the first communication device and adjacent to the second communication device. The wireless device is configured to receive the cable ID adjacent to the first communication device. In some examples, the wireless device is further used to identify the cable adjacent to the second communication device. For example, the cable comprises short-range wireless communication circuitry allowing for identification of the cable adjacent an end for connection to the first communication device, e.g. with the cable ID determined adjacent to the first communication device. This allows for identification of a cable for which the two ends of a cable are difficult for an engineer to associate together, e.g. in the case of a long cable, many similar cables close together or a cable with a path which is not fully visible.

In step 504, the wireless device transmits, using its short-range wireless communication circuitry, an indication of the value of the signal characteristic associated with the identified cable to short-range wireless communication circuitry of the second communication device. That is, the cable ID determined in step 502 is paired to its associated signal characteristic (see step 500), and an indication of the signal characteristic or related parameter is transmitted using the short-range wireless communication circuitry of the wireless device. The wireless device 140 may be held in close proximity to the communication device 120 (and particularly to the short-range wireless communication circuitry thereof) to improve the signal strength of the transmission received at the communication device 120.

Note that the indication of the value for the signal characteristic may comprise the signal characteristic itself (e.g., the optical wavelength of the signal, the direction of transmission, etc) or a proxy for the value of the signal characteristic. For example, the wavelength, the direction of transmission and/or a combination of the wavelength and the direction may be represented by a proxy variable, such as an index or other variable that corresponds to the wavelength, the direction of transmission, or a combination thereof. Those skilled in the art will appreciate that the connector ports are associated with particular wavelengths, directions of transmission, and/or combinations thereof. Thus, in some embodiments, the identity of the port (e.g., a port number or other identifier) may be used as a proxy for the values of the signal characteristic. In such a case, the wireless device 140 transmits an indication of the connector port ID associated with the cable ID.

In one embodiment, step 504 is performed responsive to an input or instruction received from a user of the wireless device. For example, the user (e.g., the engineer) may click a button or make some other input on an input/output interface, instructing the wireless device to transmit the indication of the value of the signal characteristic. In another embodiment, step 504 may be performed automatically once the cable ID is identified in step 502. That is, the wireless device may automatically transmit an indication of the signal characteristic upon determination of the associated cable ID, e.g., upon reception of the response message 502b.

In step 506, the communication device 110, 120 activates a corresponding visible indicator device responsive to a determination that the indicated value for the signal characteristic corresponds to a stored value associated with the visible indicator device. In this context, the indicated value may correspond to the stored value if the values match in whole, or in relevant part. In another example, the stored value may correspond to the indicated value where the indicated value comprises a range of values, and the stored value falls within the range.

That is, in step 506, the short-range wireless communication circuitry of the communication device 110, 120 receives an indication of a value of the signal characteristic for a communication signal carried by a cable. The indicated value is compared to one or more stored values for the signal characteristic and, responsive to a determination that the indicated value corresponds to one of the stored values, the corresponding visible indicator device is activated, e.g. lights up. If the indicated value does not correspond to a stored value, the corresponding visible indicator device is not activated, or another of the visible indicator devices of the visible indicator assembly 300 is activated to show a negative match.

The engineer is therefore provided with an explicit visual indication of a connector port that the cable should be connected to. The cable connector can be inserted into the correct port, and this process repeated for each cable until all cables have been connected to the communication device 110, 120.

As noted above, the short-range wireless communication circuitry of the communication device 110, 120 may comprise a plurality of separate communication circuits, with each circuit being associated with one or more respective connector ports and corresponding visible indicator devices. The user may therefore hold the wireless device 140 in close proximity to each of these separate communication circuits, such that the indication of the value for the signal characteristic is provided to each circuit. Note that, typically, only one of the connector ports for the communication device 110, 120 will correspond to the transmitted value. Thus the corresponding visible indicator device may only be activated once the wireless device 140 is held in close proximity to the corresponding communication circuit for that connector port.

In the embodiments described above, a visible indicator device is activated responsive to a correspondence between the indicated value of the signal characteristic and the stored value, and not activated responsive to a lack of a correspondence between the indicated value of the signal characteristic and the stored value. In alternative embodiments, a connector port may be associated with first and second visible indicator devices, e.g., having different colours or appearances. The first visible indicator device may be activated responsive to a correspondence between the indicated value and the stored value (while the second visible indicator device is not so activated); the second visible indicator device may be activated responsive to no correspondence between the indicated value and the stored value (while the first visible indicator device is not so activated). In further alternative embodiments, a single visible indicator device may be configured to provide multiple visual indications (e.g., different colours) responsive to a correspondence or a lack of a correspondence between an indicated value for the signal characteristic and a stored value. In this way, the user is provided with an explicit visual notification when a particular connector port is not the correct port for a particular cable.

As noted above, in some embodiments of the disclosure, the wireless device 140 and the communication devices 110, 120 use short-range wireless communication circuitry to communicate with each other. The communication may utilize near-field communication (NFC), or other communication technologies, whereby one device is powered inductively by the electromagnetic field generated by the other device involved in the communication. In embodiments of the disclosure, the short-range wireless communication circuitry of the communication devices 110, 120 and/or the cables 130 may be powered by the electromagnetic field generated by the short-range wireless communication circuitry of the wireless device 140. As such, the communication devices 110, 120 may be passive devices, powered only by the RF signal received from the wireless device 140.

FIG. 6 shows short-range wireless circuitry 600 according to embodiments of the disclosure, such as may be used in either or both the communication devices 110, 120 (e.g., as circuitry 230, 310), and/or the cable.

The circuitry 600 comprises an antenna 610, processing circuitry 620, a visible indicator device 630, a memory 640, a power generator module 650, receiver radio-frequency circuitry 660, and first and second capacitors 670, 680. It will be understood that the functions described may be achieved using different electrical components and/or a different arrangement of components. For example, the use of first and second capacitors 670, 680 is merely an example and the functions described may be implemented using other circuit arrangements. The antenna is coupled to the receiver RF circuitry 660 via the first capacitor 670 in series. The power generator module 650 is coupled to the antenna 610 and the receiver RF circuitry 660. The power generator 650 is further coupled to electric ground via the second capacitor 680. The receiver RF circuitry is coupled to both the processing circuitry 620 and the memory 640. The processing circuitry 620 is further coupled to the visible indicator device 630 (which is separate from the wireless circuitry 600 in some embodiments).

The signal transmitted by the wireless device 140 is configured to both transmit energy to power the short-range wireless circuitry 600 and be encoded with the indication of a value of a signal characteristic or a proxy value. In operation, the short-range wireless circuitry of the wireless device 140 is brought into proximity of the antenna 610. The wireless device 140 transmits an electromagnetic, e.g. radio frequency, signal which is received by the short-range wireless circuitry 600. The antenna 610 picks up an electromagnetic field (e.g., an electric field, a magnetic field, or a combination of both) generated by the short-range wireless circuitry of the wireless device 140. The electromagnetic field may be encoded with the indication of a value of a signal characteristic or a proxy value, as described above, using any suitable encoding or modulation scheme (e.g., phase modulation, amplitude modulation, quadrature amplitude modulation, etc). The energy induced in the antenna 610 is stored and managed by the power generator module 650 in combination with the second capacitor 680. For example, the antenna 610, acting like a spire (coil), may generate an electric field in response to a magnetic field generated by the short-range wireless circuitry of the wireless device 140. The energy from this electric field is stored in the second capacitor 680, and released to other components of the circuitry 600 by the power generator module 650. Alternatively or additionally, repeated electromagnetic pulses in the field generated by the short-range wireless circuitry of the wireless device 140 are detected by the antenna 610 and build energy in the second capacitor 680.

The power generator module 650 provides power to the receiver RF circuitry 660, which decodes the signal encoded in the electromagnetic field detected by the antenna 610. The power is further cascaded to the processing circuitry 620, the memory 640 and/or the visible indicator device 630.

The decoded signal is provided to the processing circuitry 620 and/or the memory 640, with the processing circuitry 620 comparing the received indication of the value for the signal characteristic to the one or more values stored in the memory 640 (one value if the circuitry 600 is associated with a single connector port and visible indicator device; multiple values if the circuitry 600 is associated with multiple connector ports and visible indicator devices). Note that, in the illustrated embodiment, the circuitry 600 is associated with a single visible indicator device 630; in other embodiments, the circuitry 600 may be associated with multiple visible indicator devices.

Responsive to a correspondence between the received value for the signal characteristic and one of the stored values, the processing circuitry activates a corresponding visible indicator device 630.

Thus, the radio frequency signal transmitted by the wireless device is used by the short-range wireless circuitry 600 to receive the indication of a value of a signal characteristic or a proxy value, and power processing circuitry which compares the received the indication of a value of a signal characteristic or a proxy value with a stored value. Based on the output of the comparison, the radio frequency signal transmitted by the wireless device is also used to power a visible indicator device, e.g. to indicate that there is a match in the values and that the associated port is correct for that cable. For example, the powering of the visible indicator device comprises powering a LED for a period of time to indicate the port to a user. Since the short-range wireless circuitry 600 and visible indicator devices are powered from the RF signal of the wireless device, the second communication device can be a passive device without requiring an external power source.

FIG. 7 is a schematic diagram of a wireless device 700 according to embodiments of the disclosure.

The wireless device 700 comprises processing circuitry 710, memory 720, short-range wireless communication circuitry 730, an input/output interface 740, and a power source 750.

The wireless device 700 may be adapted to identify connector components in a communication device comprising a plurality of connector ports for receiving corresponding connectors affixed to cables carrying optical signals, a plurality of visible indicator devices associated with the connector ports and short-range wireless communication circuitry. For example, the communication device may correspond to any of the communication devices 110, 120, 200 described above. The wireless device 700 may be configured to perform the method described above with respect to the wireless device 140 and FIG. 5.

According to embodiments of the disclosure, the processing circuitry 710 is configured to cause the wireless device to: receive, via the input/output interface, an indication of an association between an identifier of a cable and a value of a signal characteristic of a communication signal carried by the cable; and transmit, using the short-range wireless communication circuitry, an indication of the value of the signal characteristic to short-range wireless communication circuitry of the communication device, such that a corresponding visible indicator device is activated.

In another embodiment, the processing circuitry and visible indicator devices are powered by a conventional electrical power source, e.g. a battery or a wired electrical power connection.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A communication device, comprising:
a plurality of connector ports for receiving corresponding connectors affixed to cables carrying optical signals, the plurality of connector ports comprising a first connector port configured to receive optical signals having a first value for a signal characteristic, and a second connector port configured to receive optical signals having a second value for the signal characteristic;
a plurality of visible indicator devices associated with the connector ports, the plurality of visible indicator devices comprising a first visible indicator device located adjacent to the first connector port, and a second visible indicator device located adjacent to the second connector port; and
short-range wireless communication circuitry configured to:
receive, from a short-range wireless communication device, an indication of a value of the signal characteristic for a communication signal carried by a cable; and
responsive to a determination that the indicated value for the signal characteristic corresponds to the first value, activate the first visible indicator device.

2. The communication device according to claim 1, wherein each connector port of the plurality of connector ports is associated with a respective value of the signal characteristic.

3. The communication device according to claim 1, wherein each visible indicator device is associated with a respective connector port.

4. The communication device according to claim 1, wherein the short-range wireless communication circuitry is passive.

5. The communication device according to claim 1, wherein the short-range wireless communication circuitry comprises near-field communication, NFC, circuitry.

6. The communication device according to claim 1, wherein the short-range wireless communication circuitry comprises a plurality of short-range wireless communication circuits, each short-range communication circuit being configured to power a respective visible indicator device using a signal from the short-range wireless communication device.

7. The communication device according to claim 1, wherein the signal characteristic comprises one or more of: a wavelength of the optical signal; and a direction of the optical signal.

8. The communication device according to claim 7, wherein the wavelength of the optical signal corresponds to an identifier for the connector port.

9. The communication device according to claim 1, wherein the communication device comprises an optical filter coupled for one or more of receiving optical communication signals from the plurality of connector ports and outputting optical communication signals to the plurality of connector ports.

10. The communication device according to claim 1, wherein the visible indicator devices comprise one or more of: light-emitting diodes and electro-chromic devices.

11. (canceled)

12. (canceled)

13. A method, performed by a wireless device, for identifying connector components in a communication device comprising a plurality of connector ports for receiving corresponding connectors affixed to cables carrying optical signals, a plurality of visible indicator devices associated with the connector ports and short-range wireless communication circuitry, wherein the wireless device comprises an input/output interface, and short-range wireless communication circuitry, the method comprising:
receiving, via the input/output interface, an indication of an association between an identifier of a cable and a value of a signal characteristic of a communication signal carried by the cable; and
transmitting, using the short-range wireless communication circuitry, an indication of the value of the signal characteristic to short-range wireless communication circuitry of the communication device, such that a corresponding visible indicator device is activated.

14. The method according to claim 13, further comprising:
transmitting, using the short-range wireless communication circuitry, a query or read message to a short-range wireless communication device of the cable; and
receiving, using the short-range wireless communication circuitry, a response message from the short-range wireless communication device of the cable comprising an indication of the identifier of the cable.

15. The method according to claim 14, wherein the indication of the value of the signal characteristic is transmitted responsive to reception of the response message.

16. The method according to claim 13, wherein the indication of the value of the signal characteristic is transmitted responsive to a user input received on the input/output interface specifying the value of the signal characteristic or the identifier of the cable.

17. The method according to claim 13 wherein the short-range wireless communication circuitry of the wireless device comprises near-field communication circuitry.

18. A wireless device, for identifying connector components in a communication device comprising a plurality of connector ports for receiving corresponding connectors affixed to cables carrying optical signals, a plurality of visible indicator devices associated with the connector ports and short-range wireless communication circuitry, wherein the wireless device comprises processing circuitry, an input/output interface, and short-range wireless communication circuitry, and wherein the processing circuitry is configured to cause the wireless device to:
receive, via the input/output interface, an indication of an association between an identifier of a cable and a value of a signal characteristic of a communication signal carried by the cable; and
transmit, using the short-range wireless communication circuitry, an indication of the value of the signal characteristic to short-range wireless communication circuitry of the communication device, such that a corresponding visible indicator device is activated.

19. The wireless device according to claim 18, wherein the processing circuitry is further configured to cause the wireless device to:
transmit, using the short-range wireless communication circuitry, a query or read message to a short-range wireless communication device of the cable; and
receive, using the short-range wireless communication circuitry, a response message from the short-range wireless communication device of the cable comprising an indication of the identifier of the cable.

20. The wireless device according to claim 19, wherein the indication of the value of the signal characteristic is transmitted responsive to reception of the response message.

21. The wireless device according to claim 18, wherein the indication of the value of the signal characteristic is transmitted responsive to a user input received on the input/output interface specifying the value of the signal characteristic or the identifier of the cable.

22. The wireless device according to claim 18, wherein the short-range wireless communication circuitry of the wireless device comprises near-field communication circuitry.
